(19) United States
(12) Patent Application Publication
(10) Pub. No.: US 2023/0278500 A1
(43) Pub. Date: Sep. 7, 2023

(54) Truck Load Bed Ingress and Egress Assembly

(71) Applicant: Edwin Parish, Wichita, KS (US)

(72) Inventor: Edwin Parish, Wichita, KS (US)

(21) Appl. No.: 18/196,300

(22) Filed: May 11, 2023

(51) Int. Cl. B60R 3/00; B60Q 1/30

(52) U.S. Cl. CPC B60R 3/007; B60Q 1/307

(57) ABSTRACT

A truck load bed ingress and egress assembly incorporating a tailgate clearance arm; a column fixedly attached to and extending upwardly from a distal end of the tailgate clearance arm; a step mounted at the tailgate clearance arm's distal end; and a light mounted at the column's upper end, the column constituting a handle which secures foot placement upon the step by stabilizing a user, the column further constituting a light mount which further secures the foot placements upon the step by illuminating the step.

### FIELD OF THE INVENTION

The instant invention relates to auxiliary implement assemblies which are adapted for assisting users and operators of trucks with entering and exiting the trucks' rear load beds. More particularly, the invention relates to such assemblies and implements which are adapted for attachment to a truck's rear towing receiver hitch.

### BACKGROUND OF THE INVENTION

Pickup trucks commonly have a pivoting rear tailgate which may be lowered to a horizontal position for access to the truck's load bed. Upon lowering of such tailgate, the tailgate commonly overlies the ground between 19″ and 22″. Due to the height of such opened tailgate, it is often awkward and dangerous for a truck operator to attempt to step up and onto the tailgate for purposes of entering the truck load bed. The height of such tailgates gives rise to further dangers where the operator attempts to exit the truck load bed by stepping down from the tailgate.

During hours of darkness, the truck operator's attempts to step onto the truck tailgate or to stepdown from the tailgate give rise to additional dangers. Darkness may prevent an operator who attempts to enter the load bed from seeing items stored at the rear of the truck load bed; such items potentially interfering with the operator's foot placements. The darkness may also complicate the operator's foot placements upon exiting the load bed, preventing the operator from seeing objects or ground conditions which may interfere with stable and secure foot placements.

The instant inventive truck load bed ingress and egress assembly solves or ameliorates the truck load bed ingress and egress challenges discussed above by providing specialized components which are attachable as an auxiliary implement to the truck's rear trailer towing receiver hitch. The instant invention's specialized components multiply function as an intermediate level step between the ground and the tailgate, as a stabilizing handle which assists in use of such step, and as a step illuminating lamp which further assists in use of such step.

### BRIEF SUMMARY OF THE INVENTION

A first structural component of the instant inventive truck load bed ingress and egress assembly comprises a tailgate clearance arm or first arm, such arm having a forward proximal end and a distal end. In a preferred embodiment, the proximal end of such arm is fitted for nesting forward extensions into a truck's rear towing receiver hitch. Where such hitch presents left and right latch pin receiving eyes, the proximal end of the tailgate clearance arm preferably correspondingly presents left and right eyes. Upon alignment of such eyes with the hitch's eyes, a latch pin may be laterally extended therethrough, securely attaching the inventive assembly to the truck. The tailgate clearance arm has a rearwardly extending length dimension sufficient to span the undersurface of the truck's opened truck tailgate, such arm is preferably being composed of steel square tubing.

A further structural component of the instant inventive assembly comprises a columnar handle or vertical shaft which is fixedly and rigidly mounted at, and which extends upwardly from, the distal end of the tailgate clearance arm. Like the tailgate clearance arm, the handle is preferably composed of steel square tubing.

A further structural component of the assembly comprises a horizontal step which is rigidly mounted at the distal end of the tailgate clearance arm, such mount preferably positioning the horizontal step at the lower end of the handle. In a suitable embodiment, the step component comprises a leftwardly or rightwardly extending flange, and in the preferred embodiment, the step is configured as a “T” flange which presents both leftwardly extending and rightwardly extending step surfaces.

A further structural component of the instant inventive assembly comprises a lamp assembly which incorporates an electric light and a cantilevering boom arm extending the electric light from the handle, the lamp assembly being fixedly attached to the upper end of the handle.

In use of the instant inventive truck load bed ingress and egress assembly, an operator of a truck, typically a pickup truck, may initially extend the proximal end of the tailgate clearance arm forwardly into the rearward opening of the truck's towing receiver hitch. Thereafter, a latch pin may be extended laterally through aligned eyes of such arm and the truck's receiver, the latch pin extension securely attaching the assembly to the rear of the truck.

Thereafter, the truck operator may lower the truck's rear tailgate to its horizontal position, and the operator may activate the lamp assembly's electric light. In a preferred embodiment, the lamp assembly is adapted to illuminate surfaces including those immediately to the rear of the truck's tailgate, the step's surfaces, the upper surface of the lowered tailgate, and load bed surfaces at the rear of the truck.

In a preferred embodiment of the inventive assembly, the step component at least extends either leftwardly or rightwardly from the lower end of the handle. Where, for example, the step extends rightwardly, the operator may approach the lowered tailgate immediately to the right of the tailgate clearance arm and handle. Thereafter, the operator may use his left hand to grasp the upper end of the handle and he may move his left foot into stepping contact with the rightwardly extending step. While the operator raises and places his left foot, the lamp assembly illuminates both the step and ground surface at the operator's right foot, advantageously assisting in achieving secure foot placements.

Thereafter, the operator may transfer weight to the left foot, raising his right foot from the ground onto the horizontal tailgate surface. Upon retransferring weight from the left foot to the right foot on the tailgate, the operator may raise his left foot to the tailgate surface, finally standing upon the tailgate. During execution of such stepping actions, the operator's grip upon the handle advantageously stabilizes the operator, preventing slippage and falling.

Where the inventive assembly presents the preferred “T” flange configured step, the operator may mirroringly execute the above truck bed access steps while grasping the handle with his right hand and initially stepping with his right foot. In use of the inventive assembly for assistance in exiting the truck's load bed, steps described above may be reversed.

In a preferred embodiment, the lamp assembly comprises a cantilevering arm or second arm whose proximal end may suitably comprise a wholly formed bend in the square tubing at the upper end of the handle and at the second arm's proximal end. The lamp assembly suitably further comprises an LED electric light, which is supported at the cantilevering arm's distal end. The cantilevering arm component of the lamp assembly advantageously allows the electric light to more effectively illuminate various areas at the rear of the truck. Where such cantilevering arm is provided, a swivel joint may be advantageously incorporated into the handle so that the lamp assembly's light may be selectively orbitally moved to overlie the truck's lowered tailgate and areas at the rear of the truck.

Accordingly, objects of the instant invention include the provision of a truck load bed ingress and egress assembly which incorporates structures, as described above, and which arranges those structures in relation to each other in manners described above, for the performance of beneficial functions, as described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of the instant inventive truck load bed ingress and egress assembly.

FIG. 2 is a partial sectional view of the structure of FIG. 1, as indicated in FIG. 1.

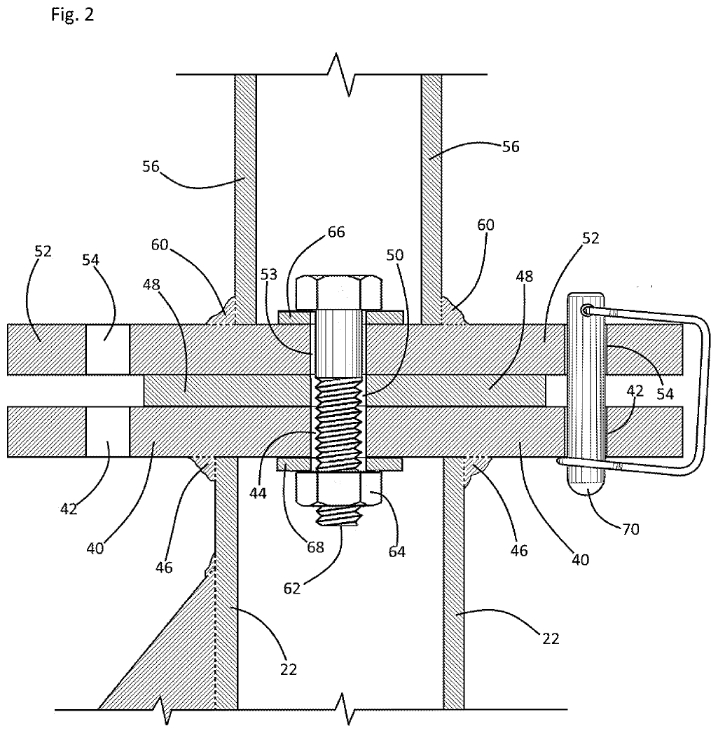

FIG. 3 re-depicts the structure of FIG. 1, the view of FIG. 3 showing electric light and cantilevering arm lamp assembly components orbitally moved forwardly.

### DETAILED DESCRIPTION OF THE INVENTION

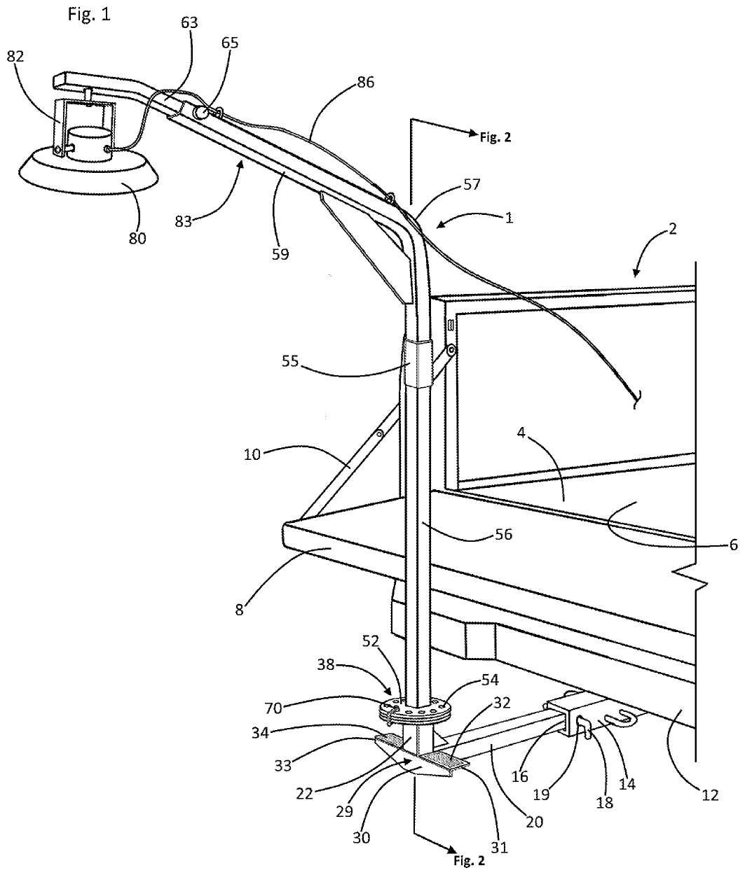

Referring now to the drawings, and in particular drawing FIG. 1, a preferred embodiment of the instant inventive truck load bed ingress and egress assembly is referred to generally by reference arrow 1. The assembly is generally intended for use in connection with a pickup truck which is designated generally by reference arrow 2, the pickup truck having a rear load bed 4, a rear load bed opening 6, a downwardly pivotable tailgate 8, and a pivot stopping link arm 10. Upon lowering the tailgate 8 to the horizontal position depicted in FIG. 1, the tailgate 8 overlies the truck's rear bumper 12, and overlies ground areas to the rear of the truck. In a typical tailgate configuration, the vertical distance between the ground and the lowered tailgate 8 is approximately 22 inches.

A towing receiver hitch 14 is commonly rigidly mounted beneath truck's bumper 12, such receiver hitch 14 having a rearwardly opening socket 16, and having pin receiving eyes 19 for lateral receipt of an implement attaching latch pin 18.

A first or foundational structural component of the instant inventive assembly comprises a tailgate clearance arm or first 20 having a proximal end which is forwardly received within the towing receiver's socket 16. In a preferred embodiment, the proximal end of such arm 20 has laterally opening eyes (not within views) which may be aligned with eyes 19 for secure simultaneous receipt of the latch pin 18.

A further structural component of the instant inventive assembly comprises a columnar vertical shaft or handle 56 which is fixedly and rigidly mounted at, and extends upwardly from, the distal end of the tailgate clearance arm 20. In a suitable embodiment, the handle component comprises a lower segment which functions as a mounting pedestal 22, such lower segment being fixedly welded to the distal end of the tailgate clearance arm 20. In the preferred embodiment, the handle 56, including its mounting pedestal 22 segment, is composed of durable steel square tubing. To facilitate secure manual grasping of the handle 56, a high friction elastomeric hand grip 55 may be fixedly attached to the handle near the handle's upper end.

A further structural component of the instant inventive assembly comprises a step assembly which is referred to generally by reference arrow 29. In a preferred embodiment, the step assembly 29 comprises at least a first durable and ridged flange which extends laterally,either rightwardly or leftwardly, from the tailgate clearance arm 20. In the depicted preferred embodiment the step assembly 29 is configured as a “T” member or “T” flange which presents both a rightwardly extending step 31 and a leftwardly extending step 33. A reinforcement flange 30 preferably extends downwardly from forward edges of steps 31 and 33. The step assembly 29 is preferably rigidly welded to the lower end of handle's pedestal segment 22. In a preferred embodiment high friction traction pads 32 and 34 are respectively adhesively attached to upper surfaces of the step flanges 31 and 33 to facilitate secure, stable and slip free foot placements thereon.

A further structural component of the instant inventive assembly comprises a lamp assembly which is referred to generally by reference arrow 83. The lamp assembly is preferably fixedly mounted at the upper end of the handle 56, such mount suitably being effected by a wholly formed bend 57. The lamp assembly 83 suitably comprises an electric LED light 80, which is powered by a power cord 86. Suitably, such LED light may be alternatively powered by onboard batteries. In a suitable embodiment the LED light 80 component of the lamp assembly 83 is mounted to the handle 56 by a cantilevering boom arm or second arm 59 component of such assembly. In a preferred embodiment, the boom arm incorporates an extendable and retractable telescoping section 63. Accordingly, the lamp assembly's cantilevering arm component preferably comprises a telescoping quill and stem combination having an outer quill 59 and an inner sliding stem 63. A releasable set screw 65 is suitably provided for releasably fixing the stem component 63 at a desired extension. A multi-position facilitating swivel bracket 82 is suitably provided for connecting the light 80 to the distal end of the boom arm 59,63.

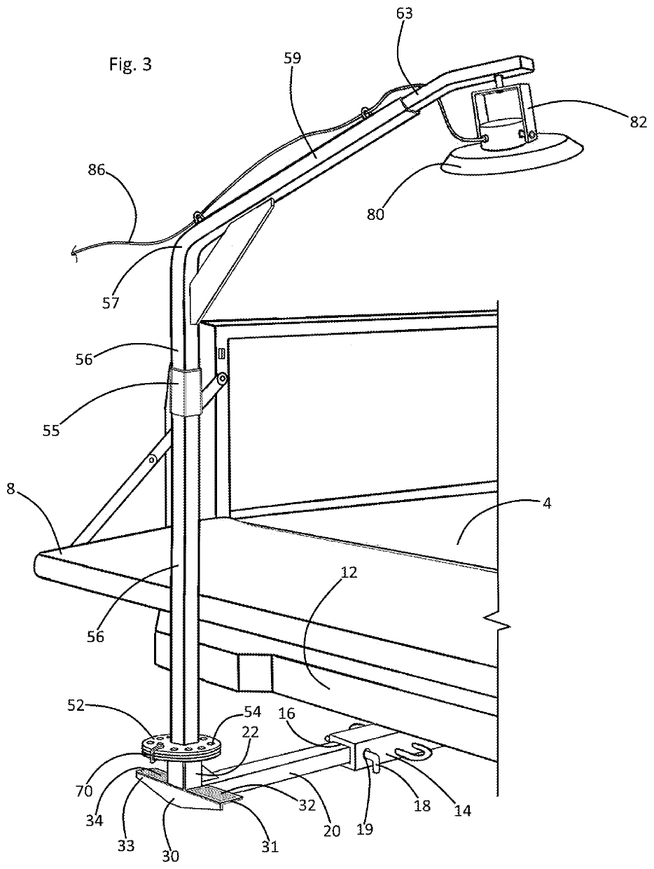

Referring simultaneously to all figures, to allow the lamp assembly 83 to be selectively orbitally moved to various positions, such as Fig. l′s position overlying the ground at the rear of the truck 2 or FIG. 3′s position overlying the upper surface of the tailgate 8, a swivel joint, referred to generally by reference arrow 38, may be provided. Such joint interconnects the handle's upper and lower segments 56 and 22 and facilitates rotary motion of the upper segment 56 about a vertical axis with respect to the lower segment 22.

In the depicted preferred embodiment, the swivel joint 38 comprises upper and lower circular friction plates 52 and 40, and an interstitial shaft stabilizing friction plate 48 which is compressively held there between. The upper plate 52 is preferably fixedly welded to the lower end of the upper handle segment 56 by means of welds 60, and the lower plate 40 is similarly fixedly welded to the upper end of the handle's pedestal segment 22 by welds 46.

The swivel joint's upper and lower plates 52 and 40 suitably present circular arrays of pin receiving eyes 54 and 42, such arrays preferably being arranged to achieve multiple vertical alignments for facilitation of multiple selected rotary positions. Upon eye alignments at a selected rotary position, a lock pin and retainer clip combination 70 may be installed within any or the vertically aligned pairs of the eyes 54 and 42 to releasably secure the plates at the selected position.

Plates 52, 48, and 40 respectively have central apertures 53, 50, and 44, which, upon vertical alignment, form a central bolt receiving channel which receives a handle segment connecting bolt, nut and washer combination 62, 64, 66, 68.

In a suitable embodiment, the upper and lower plates 52 and 40 may be composed of steel while the interstitial plate 48 may be composed of high density and low friction HDPE (high density polyethylene) plastic. Where the interstitial plate 48 is composed of HDPE, tightening of the nut and bolt fastener 62, 64, advantageously rigidly stabilizes the upper handle segment 56 while allowing the handle to be slidably rotated with respect to the pedestal segment 22. Accordingly, the HDPE plate 48 multiply functions as a rotary bearing and as a handle stabilizer.

The circular arrays of pin receiving eyes 54 and 42 advantageously allow the orbital position of the light 80 and boom arm 59,63 to be releasably secured at a selected position via lock pin 70. Upon orbital swiveling of the lamp assembly 83, including light 80 and boom arm 59,63, to the rearwardly cantilevering position as depicted in FIG. 1, lock pin 70 may extend vertically through aligned eyes 54 and 42 to secure such components in such selected positon. Referring to FIG. 3, the lamp assembly 83 may be alternatively orbitally moved to and releasably locked at, for example, a relatively forwardly cantilevering position which overlies the tailgate 8 and the rear of the truck's load bed 4.

In use of the instant inventive assembly, an operator may grasp the upper hand grip 55 of the handle 56 while raising his left or right foot onto one of the frictional step surfaces 32 or 34. Thereafter, the operator may easily and conveniently step up onto the tailgate while being stabilized by the handle 56. Thereafter, upon the operator's exit from the load bed, the handle 56 may further assist and stabilize the operator's downward step from the tailgate 8 onto the step surface 32 or 34. During periods of darkness the lamp assembly 83 advantageously illuminates the step surfaces 32 and 34 and adjacent areas, further assisting in the prevention of slippage and falls.

The assembly's vertical shaft 56 advantageously multiply functions in promotion of the common objective of the operator's secure stepping during ingress and egress to and from the truck bed, such shaft functioning both as a handle, which stabilizes the operator during stepping, and as a light support, which facilitates illumination of the assembly's step surfaces.

While the principles of the invention have been made clear in the above illustrative embodiment, those skilled in the art may alter and vary the components and arrangements of components of the invention without departing from those principles. Accordingly, it is intended that the description and drawings be interpreted as illustrative and not in the limiting sense, and that the invention be given a scope commensurate with the appended claims.

1. I claim a truck load bed ingress and egress assembly comprising:
a) A first arm having proximal and distal ends;
b) A handle having upper and lower ends, the handle being rigidly mounted at and extending upwardly from the first arm's distal end;
c) A step rigidly mounted at the first arm's distal end; and
d) A lamp assembly mounted at the handle's upper end.

2. The truck load bed ingress and egress assembly of claim 1, wherein the lamp assembly comprises a second arm fixedly attached to and cantilevering from the handle's upper end.

3. The truck load bed ingress and egress of claim 2, wherein the lamp assembly comprises an electric light operatively mounted upon a distal end of the second arm.

4. The truck load bed ingress and egress assembly of claim 3, wherein the handle comprises an upper segment and a lower segment, and further comprising a swivel joint interconnecting said segments.

5. The truck load bed ingress and egress assembly of claim 4, wherein the second arm comprises a telescoping quill and stem combination.

6. The truck load bed ingress and egress assembly of claim 4, wherein the swivel joint comprises upper and lower friction plates.

7. The truck load bed ingress and egress assembly of claim 6, wherein the swivel joint comprises upper and lower pluralities of eyes respectively opening at the upper and lower friction plates, and further comprising a lock pin extending through a vertically aligned pair of said eyes.

8. The truck load bed ingress and egress assembly of claim 1, wherein the step comprises a “T” flange having left and right step surfaces.

9. The truck load bed ingress and egress assembly of claim 8, comprising left and right friction pads respectively attached to the left and right step surfaces.

10. The truck load bed ingress and egress assembly of claim 1, further comprising receiver hitch pin receiving eyes opening at the proximal end of the first arm.

11. The truck load bed ingress and egress assembly of claim 3, wherein the operative mount of the electric light comprises a swivel bracket interconnecting the electric light and the second arm's distal end.

12. The truck load bed ingress and egress assembly of claim 5, further comprising a set screw operatively mounted at a distal end of the telescoping quill and stem combination's quill, said set screw being adapted for alternately permitting and resisting extending and retracting movements of said combination's stem.
